(19) United States
(12) Patent Application Publication
(10) Pub. No.: US 2026/0180201 A1
(43) Pub. Date: Jun. 25, 2026

(54) BASE STATION ANTENNA SYSTEMS HAVING ADJUSTABLE REFLECTORS IN CYLINDRICAL RADOMES

(71) Applicant: OUTDOOR WIRELESS NETWORKS LLC, Richardson, TX (US)

(72) Inventors: Mohamed Nadder HAMDY, Melbourne (AU); Honghui LI, Suzhou, Jiangsu (CN); PuLiang TANG, Suzhou, Jiangsu (CN); Hangsheng WEN, Suzhou, Jiangsu (CN); Shuguang SHAO, Suzhou, Jiangsu (CN)

(21) Appl. No.: 19/127,446

(22) PCT Filed: Nov. 1, 2023
(86) PCT No.: PCT/US2023/078293

§ 371 Date: May 6, 2025

(30) Foreign Application Priority Data
Nov. 11, 2022 (CN) 202211408858.2

(51) Int. Cl. H01Q 19/10; H01Q 1/24; H01Q 21/24; H01Q 21/30

(52) U.S. Cl. CPC H01Q 19/10; H01Q 1/246; H01Q 21/24; H01Q 21/30

(57) ABSTRACT

A base station antenna sector includes: a first reflector comprising a first flat panel and a plurality of first radiating elements mounted thereon; a second reflector comprising a second flat panel and plurality of second radiating elements mounted thereon; a radome surrounding the first and second reflectors; wherein the second reflector is pivotally movable relative to the first reflector.

### RELATED APPLICATION

The present application claims priority from and the benefit of Chinese Patent Application No. 202211408858.2, filed Nov. 11, 2022, the disclosure of which is hereby incorporated herein by reference in full.

### FIELD

invention generally relates to radio communications and, more particularly, to base station antenna systems that support communications in multiple frequency bands.

### BACKGROUND

Cellular communications systems are well known in the art. In a cellular communications system, a geographic area is served by a number of cellular sites. A cellular site can be further divided into smaller cells, called sectors.

Each sector may include one or more base station antennas (BSA) that are configured to provide Multiple Input Multiple Output (MIMO) Radio Frequency communications, with mobile subscribers that are within the cell served by the sector.

Each BSA typically includes one or more vertically extending columns of cross polarized radiating elements (which may be straight columns or may include some horizontal stagger) that are typically referred to as “linear arrays.” A typical linear array is capable of two MIMO layers (streams), one at each of two orthogonal polarizations. Typically, a four MIMO layer configuration will require 2 horizontally spaced arrays, which increases the overall antenna width significantly (compare antennas 10′, 10″ in FIG. 1). Typically, the arrays of radiating elements are mounted on a reflector and housed inside a protective radome.

Many BSAs are mounted on a tower or other raised structure, and therefore face limitations in meeting the structural wind loading capacity. This makes an upgrade to four MIMO streams, with wider antennas, impractical in many cases. Some markets, such as Japan, favor cylindrical radome shapes, as they may experience lower wind loading. However, often when antenna(s) are housed in a cylindrical radome, a large volume in the radome remains unutilized.

One approach is to construct a base station antenna with two reflectors that are disposed so that their signal directions are separated by 120 degrees. In FIG. 2, two reflectors 120, 120′ in the antenna 110 jointly provide the four MIMO layers in the common direction of a single sector, with each reflector 120, 120′ contributing two MIMO layers. This design results in a marginal width increase from the single array antenna base line case, and significantly reduces the wind loading. However, the fixed 120 degree angular separation makes it impractical to deploy in many scenarios where the azimuth differences between the sectors are nonuniform.

### SUMMARY

As a first aspect, embodiments of the invention are directed to a base station antenna sector. The base station antenna sector comprises: a first reflector comprising a first flat panel and a plurality of first radiating elements mounted thereon; a second reflector comprising a second flat panel and plurality of second radiating elements mounted thereon; and a radome surrounding the first and second reflectors. The second reflector is pivotally movable relative to the first reflector.

As a second aspect, embodiments of the invention are directed to a base station antenna sector comprising: a first reflector comprising a first flat panel and a plurality of first radiating elements mounted thereon; a second reflector comprising a second flat panel and plurality of second radiating elements mounted thereon; and a radome surrounding the first and second reflectors. The first reflector is fixed relative to the radome, and the second reflector is pivotally movable relative to the first reflector.

As a third aspect, embodiments of the invention are directed to a base station antenna sector comprising: a first reflector comprising a first flat panel and a plurality of first radiating elements mounted thereon; a second reflector comprising a second flat panel and plurality of second radiating elements mounted thereon; and a generally cylindrical radome surrounding the first and second reflectors. The second reflector is pivotally movable relative to the first reflector about a pivot axis, the pivot axis being located between the first and second reflectors.

### BRIEF DESCRIPTION OF THE DRAWINGS

FIG. 1 is a cross-sectional top view showing the width increase of a base station antenna between an antenna with 2 MIMO layers and an antenna with 4 MIMO layers.

FIG. 2 is a cross-sectional top view of an existing BSA design, in which two reflectors are disposed within a single cylindrical radome at a 60 degree angle, with the result that the antenna's diameter is minimized, the reflectors having a fixed uniform relative azimuth between sectors of 120 degrees.

FIGS. 3A-3C are schematic cross-sectional views of a foldable base station antenna system showing the capacity for attaining different relative reflector angles, according to embodiments of the invention.

FIG. 4 is a perspective view of a base station antenna according to additional embodiments of the invention.

FIG. 5 is a bottom view of the base station antenna of FIG. 4.

FIG. 6 is a partial top perspective view of the base station antenna of FIG. 4 with the radome removed.

FIG. 7 is a top section view of the base station antenna of FIG. 4 showing the reflectors positioned to create a radiation angle of 180 degrees.

FIG. 8 is a top section view of the base station antenna of FIG. 4 showing the reflectors positioned to create a radiation angle of 120 degrees.

### DETAILED DESCRIPTION

The present invention is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

It will also be understood that, as used herein, the terms “example,” “exemplary,” and derivatives thereof are intended to refer to non-limiting examples and/or variants embodiments discussed herein, and are not intended to indicate preference for one or more embodiments discussed herein compared to one or more other embodiments.

Most mobile network operators across the globe face exponentially increasing demand of data traffic, in terms of higher throughputs and lower latencies, by their subscribers. This is partially driven by the evolution of users' smart phones capabilities. In 4G LTE, most of the smart phones supported two MIMO layers, however in 5G, majority of the devices are four MIMO layers-capable.

As 5G traffic and 5G capable devices grow, operators are re-farming their frequency assets from 4G to 5G. However, they are faced with the antenna width increase challenges in upgrading to four-layer MIMO. One challenge lies in the increased wind load which current civil structures may be unable to support, especially in the sub 1 GHz bands. As noted above, some markets, such as in Japan, favor cylindrical radome shapes that exhibit reduced wind loading resistance, with the accompanying issue that a large volume in the cylindrical radome may remain unutilized.

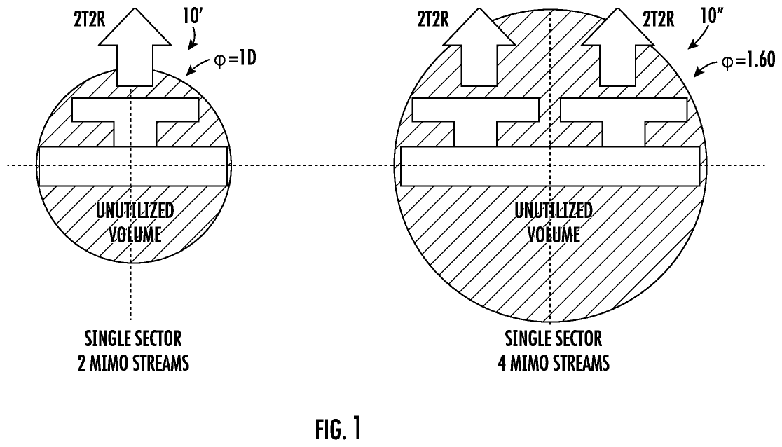

Each BSA will often include one or more linear arrays. A typical linear array is capable of transmitting and receiving two MIMO layers (streams), one at each of two orthogonal polarizations. Typically, a four MIMO layer configuration will employ two horizontally spaced arrays, which increases the overall antenna width by approximately 1.6 times (compare antennas 10, 10′ in FIG. 1). Smaller horizontal separation can result in isolation deterioration, which impacts the performance of the linear arrays.

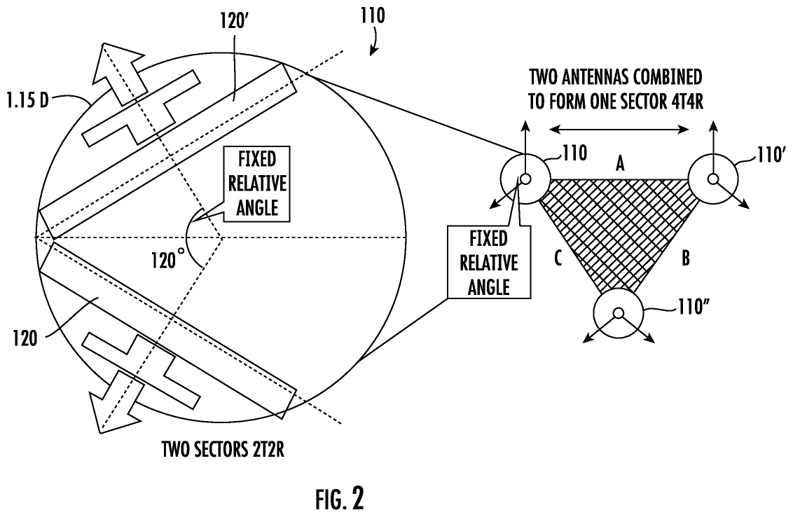

An efficient approach to minimize the diameter and utilize the radome's internal volume involves constructing a base station antenna comprising two reflectors with angular separation in between, such that each reflector points to a different direction. As illustrated in FIG. 2, antenna 110 and antenna 110′jointly construct the four MIMO streams in the common direction of sector A, with each antenna contributing a two MIMO stream. Similarly, the other two sectors B and C are jointly constructed by antenna 110′ and antenna 110″ and by antenna 110 and antenna 110″ respectively. This design results in width increase in the antenna of approximately only 1.15 from the single array antenna base line case (i.e., antenna 10 in FIG. 1), and significantly reduces the wind loading. Isolation is also easily maintained between the linear arrays.

To meet radio planning requirements, it is desirable that the relative angle between the two reflectors is adjustable. This makes the solution deployable for nonuniform sectors' azimuth.

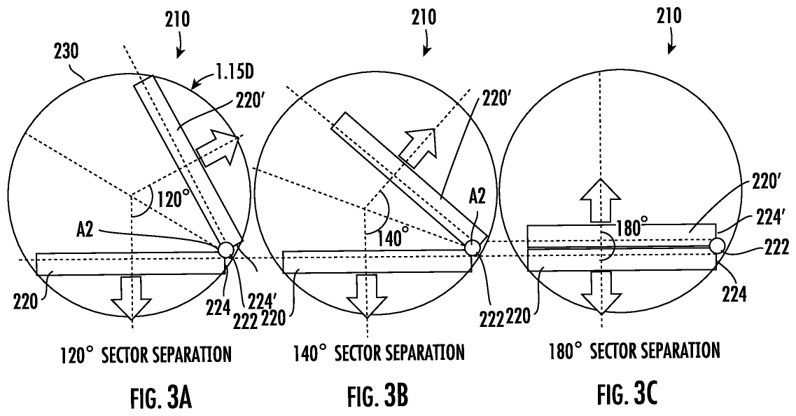

Pursuant to embodiments of the present invention, base station antenna systems are provided that overcome the above size and fixed relative angle limitations for cost-efficient four-layer MIMO upgrades. As shown schematically in FIGS. 3A-3C, an antenna 210 includes two reflectors 220, 220′ mounted within a common cylindrical radome 230. Each reflector 220, 220′ has one or more linear arrays (not shown) of radiating elements to increase the number of MIMO layers with marginal width increments.

As is shown in FIGS. 3A-3C, the reflectors 220, 220′ are mounted within the antenna 210 to be pivotable relative to each other. More specifically, in FIGS. 3A-3C the reflectors 220, 220′ are connected via a hinge 222 located at their side edges 224, 224′ that defines a pivot axis A2. This arrangement enables the reflectors 220, 220′ to be adjusted when deployed so that the angular separation of the sector can be 120 degrees (FIG. 3A—which shows an angle of 60 degrees between the reflectors 220, 220′ themselves), 180 degrees (FIG. 3C—which shows an angle of 0 degrees between the reflectors 220, 220′), or an angle between 120 and 180 degrees (e.g., 140 degrees—see FIG. 3B—which shows an angle of 40 degrees between the reflectors 220, 220′). As shown, this arrangement can be deployed within a cylindrical radome 230 with a reduced diameter compared to four MIMO sector shown in FIG. 1, which in turn can avoid unutilized volume within the radome 230.

It will be understood that the angle between the reflectors 220, 220′ (and in turn the sector angle created by the reflectors 220, 220′) may be adjusted in any number of ways. In some embodiments the reflectors 220, 220′ may be adjusted manually. In other embodiments the reflectors 220, 220′ may be coupled to a mechanism (not shown) that drives the reflectors 220, 220′ to their desired positions. In further embodiments, such a mechanism may be configured to be activated remotely, such that adjustment can occur after the antenna 210 is mounted; remote activation can save time and labor by eliminating the need for a technician to scale a tower or the like to access the antenna 210 for adjustment. Also, with remote relative angle adjustments, the sector azimuth can be periodically adjusted, as per the weekday or time of day as an optimization.

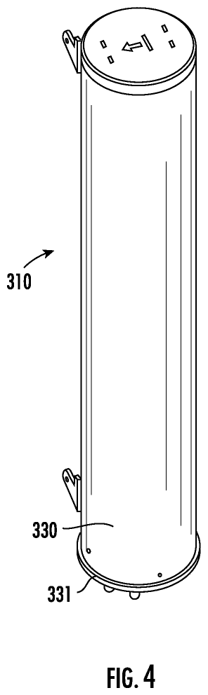

Referring now to FIGS. 4-8, another embodiment of a base station antenna, designated broadly at 310, is illustrated therein. Like the antenna 210, the antenna 310 includes two reflectors 320, 320′ mounted within a common cylindrical radome 330. Each reflector 320, 220′ has one or more linear arrays 340 to increase the number of MIMO layers with marginal width increments. However, rather than being hinged at their side edges to permit relative pivotal movement, the pivot axis A3 of the reflectors 320, 320′ is located between the reflectors 320, 320′ at or near the center of the antenna 310.

Referring to FIG. 6, it can be seen that the reflector 320 is fixedly mounted to a mounting framework 332 within the antenna 310 via a bracket 334 that extends from the rear side of the reflector 320. The reflector 320′ also has a bracket 334′ that extends from its rear surface; however, the reflector 320′ is not fixed to the framework 332. Instead, the bracket 334′ is pivotally mounted to the bracket 334 of the reflector 320 via a bolt and nut 336 that define the aforementioned pivot axis A3 (see FIG. 7). (The lower end of the antenna 310 is shown in FIG. 6; it will be understood that a similar arrangement of pivotally interconnected brackets is present at the upper end of the antenna 310). As such, the reflector 320′ is free to pivot relative to the reflector 320 about the axis A3 to create a desired sector angle.

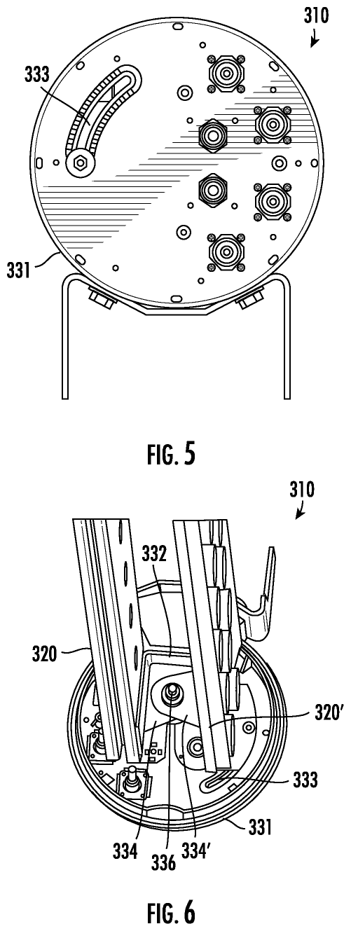

As shown in FIGS. 5 and 6, the lower end cap 331 includes an arcuate slot 333. A post, pin or the like (shown at 337 in FIG. 7) extends downwardly from the reflector 320′ and is received in the slot 333. The slot 333 helps to guide the reflector 320′ as it is being pivoted, and also serves as a “stop” to limit the angular movement of the reflector 320′ (for example, if the slot 333 extends over an arc of approximately 60 degrees, the reflector 320′ is able to pivot relative to the reflector 320 over a similar angle).

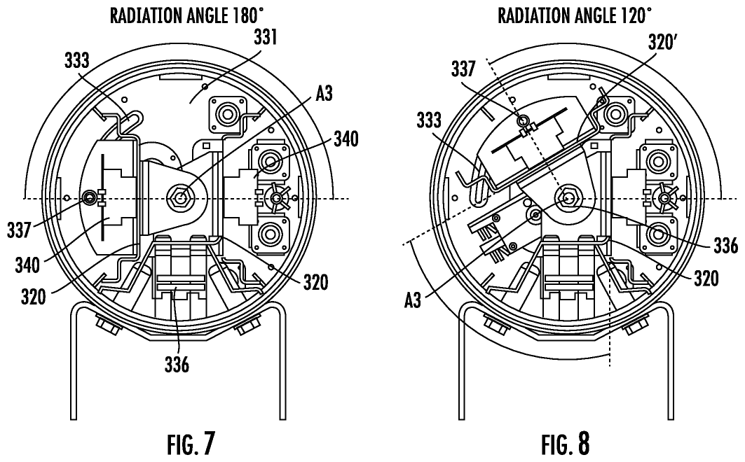

FIGS. 7 and 8 illustrate the reflectors 320, 320′ creating a radiation angle of 180 degrees (FIG. 7—similar to FIG. 3C) and a radiation angle of 120 degrees (FIG. 8 similar to FIG. 3A). It will be understood that any radiation angle between 120 degrees and 180 degrees is also achievable with the antenna 310. It will also be understood that greater or lesser limits on the angle of radiation may be created with other configurations. Further, those of skill in this art will appreciate that other pivot-limiting structures, such as pins or posts extending upwardly from the end cap 331, stop members on one or both of the brackets 334, 334′, or a bayonet-style pin and sleeve that replace the nut and bolt 336 as the defining members of the pivot axis A3, may also be employed.

Those skilled in this art will appreciate that, in some embodiments, it may be desirable for both of the reflectors 320, 320′ to pivot relative to the framework 332. Such an arrangement may provide a user with additional options when adjusting the azimuth of the antenna 320, particularly if the antenna 310 is already mounted on an antenna tower, monopole, or other structure.

Those skilled in this art will appreciate that pivotal nature of the reflectors, 220, 220′, 320, 320′ may be applicable to single and multiband arrays, and/or over all of low, mid and high frequency bands.

Also, in some embodiments, for the above-described antennas 210, 310 may be provided in combination with similar pivotable base station antennas or with conventional antennas. In such embodiments, an overall base station antenna system may be formed in two or more sectors, operating four MIMO layers per sector.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as recited in the claims. The invention is defined by the following claims, with equivalents of the claims to be included therein.

1. A base station antenna sector, comprising:
a first reflector comprising a first flat panel and a plurality of first radiating elements mounted thereon;
a second reflector comprising a second flat panel and plurality of second radiating elements mounted thereon; and
a radome surrounding the first and second reflectors;
wherein the second reflector is pivotally movable relative to the first reflector.

2. The base station antenna sector defined in claim 1, wherein the radome is generally cylindrical.

3. The base station antenna sector defined in claim 1, wherein the first reflector is fixedly mounted to a mounting framework in the radome.

4. The base station antenna sector defined in claim 1, wherein the second reflector pivots relative to the first reflector via a hinge attached adjacent side edges of the first and second reflectors.

5. The base station antenna sector defined in claim 1, wherein the second reflector pivots relative to the first reflector about a pivot axis located between the first and second flat panels.

6. The base station antenna sector defined in claim 5, wherein the pivot axis is located adjacent a center of the radome.

7. The base station antenna sector defined in claim 1, further comprising a pivot-limiting structure to limit a pivot arc of the second reflector.

8. The base station antenna sector defined in claim 1, wherein together the first and second reflectors are configured to support a four layer MIMO arrangement.

9. A base station antenna sector, comprising:
a first reflector comprising a first flat panel and a plurality of first radiating elements mounted thereon;
a second reflector comprising a second flat panel and plurality of second radiating elements mounted thereon;
a radome surrounding the first and second reflectors; and
wherein the first reflector is fixed relative to the radome, and the second reflector is pivotally movable relative to the first reflector.

10. The base station antenna sector defined in claim 9, wherein the radome is generally cylindrical.

11. The base station antenna sector defined in claim 9, wherein the second reflector pivots relative to the first reflector via a hinge attached adjacent side edges of the first and second reflectors.

12. The base station antenna sector defined in claim 9, wherein the second reflector pivots relative to the first reflector about a pivot axis located between the first and second flat panels.

13. The base station antenna sector defined in claim 12, wherein the pivot axis is located adjacent a center of the radome.

14. The base station antenna sector defined in claim 9, further comprising a pivot-limiting structure to limit a pivot arc of the second reflector.

15. The base station antenna sector defined in claim 9, wherein together the first and second reflectors are configured to support a four layer MIMO arrangement.

16. A base station antenna sector, comprising:
a first reflector comprising a first flat panel and a plurality of first radiating elements mounted thereon;
a second reflector comprising a second flat panel and plurality of second radiating elements mounted thereon; and
a generally cylindrical radome surrounding the first and second reflectors;
wherein the second reflector is pivotally movable relative to the first reflector about a pivot axis, the pivot axis being located between the first and second reflectors.

17. The base station antenna sector defined in claim 16, wherein each of the first radiating elements and the second radiating elements are MIMO radiating elements.

18. The base station antenna sector defined in claim 17, wherein together the first and second reflectors provide a four layer or higher MIMO arrangement in different frequency ranges.
